(19) United States
(12) Patent Application Publication
(10) Pub. No.: US 2014/0096902 A1
(43) Pub. Date: Apr. 10, 2014

(54) Method and Apparatus for Fabricating an Ultra-High Molecular Weight Polymer Structure

(71) Applicant: The Boeing Company, (US)

(72) Inventor: Mark J. Clemen, Jr., Bremerton, WA (US)

(73) Assignee: THE BOEING COMPANY, Chicago, IL (US)

(21) Appl. No.: 13/645,683

(22) Filed: Oct. 5, 2012

(51) Int. Cl. B32B 37/26; B32B 41/00; B32B 37/10; B32B 38/18; B32B 37/06; B32B 38/04

(52) U.S. Cl. 156/275.5; 156/60; 156/362; 901/2; 901/30

(57) ABSTRACT

A polymer laminate is fabricated by laying down layers of an ultra-high molecular weight polymer material on top of each other, and fusing the layers to each other by cross-linking molecular chains of adjoining layers.

### BACKGROUND INFORMATION

1. Field

This disclosure generally relates to fabrication of laminated polymer structures, and deals more particularly with a method and apparatus for fabricating ultra-high molecular weight laminate structures, particularly those formed from thermoplastics such as polyethylene.

2. Background

Fiber reinforced thermoset resins, such as carbon fiber epoxy, are commonly used to fabricate light weight, high strength composite laminate structures. However, these types of fiber reinforced resins, which involve formulation of mixed media, have some disadvantages. For example, their formulation may be time consuming because they require multiple manufacturing steps, and may involve frequent clean-up. Also, these resins often require special handling until cured. Structures made from fiber reinforced thermoset resins may be less resistant to some types of harsh environments, compared to other polymer-based structures, such as those formed from certain thermoplastics.

Thermoplastic laminates exhibit superior fracture toughness and avoid some of the problems of mixed media thermosets discussed above. Thermoplastic laminates are produced by stacking and melting multiple layers (plies) of a suitable thermoplastic resin, to form a consolidated structure. Although the consolidated laminate structure may exhibit desirable characteristics such as good impact and abrasion resistance, elevating the temperature of the laminate to its melt point in order to effect consolidation may have undesirable effects.

One class of thermoplastic resins of particular interest for high-performance applications is ultra-high molecular weight polymers (UHMW) such as ultra high molecular weight polyethylene (UHMWPE). UHMWPE is a subset of thermoplastic polyethylene which has extremely long molecular chains and a molecular weight usually between approximately 2 and 6 million. The longer molecular chains of UHMWPE serve to transfer load more effectively to the polymer backbone by strengthening intermolecular interactions, resulting in an extremely tough and durable material with very high impact strength. UHMWPE is highly resistant to corrosive chemicals, has low moisture absorption as well as a low coefficient of friction, while being highly resistant to abrasion.

It is known that subjecting UHMW polymers such as UHMWPE to certain kinds of radiation may improve their performance. For example, the wear resistance of UHMWPE may be improved by subjecting it to high doses of gamma radiation. It is also known that electron beam irradiation of UHMWPE creates useful changes in the material's properties and performance, such as polymer chain scissioning and cross-linking.

It would be desirable to provide a simplified method and apparatus for fabricating UHMW polymer laminates that avoids the need for melting the laminate layers in order to achieve ply consolidation. It would also be desirable to provide a process for treating such laminates that improves material properties of the consolidated laminate structure.

### SUMMARY

The disclosed method and apparatus may be used to fabricate fully consolidated, high strength, lightweight polymer structures without the use of composite fibers or intermediate resins, i.e. a mono-component. The embodiments are particularly well-suited for fabricating UHMW polymer structures, such as, without limitation, UHMWPE, not requiring reinforcements. A radiation beam, such as electron beam, is utilized to soften but not melt the layers of a laminate as they are being laid up. The energy provided by the radiation beam results in scissioning or breakage of the molecular chains, which then reform and re-bond. As the molecular chains reform, the chains in the adjoining layers of the laminate cross-link, thereby fusing the layers together into an integrated, substantially continuous and homogeneous structure. Process parameters, including radiation dosage, may be adjusted to achieve a desire ratio of molecular chain scissioning and cross-linking. Re-bonding of the molecular following scissioning results in a stronger and more unified laminate structure.

The disclosed method and apparatus permit simplified, rapid manufacturing of high-strength, lightweight aerospace structures without reinforcements, and avoid the need for materials that require special handling and/or cleanup. Because the embodiments avoid the need for heating the material to its melting point to achieve consolidation, the possibility of material degradation is reduced.

According to one disclosed embodiment, a method is provided of fabricating a polymer structure. The method comprises laying down layers of an ultra-high molecular weight (UHMW) polymer material on top of each other, and fusing the layers to each other by cross-linking molecular chains of adjoining ones of the layers. Cross-linking the molecular chains is performed by subjecting each of the layers to a beam of radiation. The method further comprises removing or replacing air with another gas from a volume surrounding the layers of the UHMW polymer material such that the layers are not subjected to oxygen while the layers are being subjected to the beam of radiation. The method may also comprise heating the layer of UHMW polymer material. Subjecting each of the layers to a beam of radiation may be performed by scanning an electron beam over the layer. Scanning an electron beam over the layers results in the accumulation of an electrostatic charge on the layers, and the method further comprises draining the electrostatic charge from the layers. Subjecting each of the layers to a beam of radiation may be also be performed by scanning a beam of gamma-rays over the layer. The UHMW polymer may be a UHMW polyethylene. Laying down the layers of a ultra-high molecular weight (UHMW) polymer material is performed using a computer controlled automatic material placement head to place strips of the UHMW polymer material in side-by-side relationship on a substrate, and subjecting each of the layers of the UHMW polymer material to a beam of radiation is performed by scanning a beam of radiation across the strips as the strips are being placed on the substrate. Laying down the layers of a UHMW polymer material on top of each other includes placing strips of the polymer material on a substrate and compacting the strips as they are being placed on the substrate, and cross-linking the molecular chains of adjoining ones of the layers includes subjecting each of the strips to a beam of radiation after the strip has been compacted.

According to another embodiment, a method is provided of fabricating an ultra-high molecular weight (UHMW) polymer structure. The method comprises placing layers of an UHWM polymer material on top of each other, and consolidating the layers, including cross-linking molecular chains of the layers by subjecting the layers to radiation sufficient in dosage to cross-link the molecular chains in adjoining ones of the layers. The UHWM polymer material may include UHMW polyethylene. Subjecting the layers to radiation includes scanning the layers with one of an electron beam, and a gamma-ray beam. The method may further comprise preventing oxidation of the molecular chains by removing oxygen from a volume surrounding the layers while the layers are being subjected to the radiation.

According to another embodiment, a method is provided of increasing the structural integrity of an ultra-high molecular weight (UHMW) laminate structure. The method comprises breaking polymer bonding chains of layers of the laminate and cross-linking molecular chains of the layers by subjecting the layers with a beam of radiation. Subjecting the layers with a beam of radiation is performed by passing one of an electron beam and a gamma-ray beam over the layers. The UHMW polymer may be UHMW polyethylene. The method further comprises removing oxygen from a volume surrounding the laminate while the layers are being subjected to radiation, and heating the laminate.

According to still another embodiment, a method is provided of fabricating a generally enclosed polymer structure having an open interior. The method comprises forming a generally enclosed multi-layer laminate having an open interior, including placing layers of an ultra-high molecular weight (UHMW) polymer material on top of each other layer-by-layer, and fusing the layers to each other by irradiating the layers with a radiation from within the open interior of the laminate. Irradiating the layers includes moving a radiation beam generator through the open interior of the laminate and directing a radiation beam radially outwardly as the layers are being placed.

According to another embodiment, apparatus is provided for fabricating a UHMW polymer structure. The apparatus comprises an end effector, including an UHMW polymer material application head adapted to place layers of the UHMW polymer material on a substrate, and a radiation beam generator for fusing layers applied by the applicator. The apparatus further comprises a robotic manipulator for manipulating the end effector, and a computerized controller for automatically controlling the operation of the robotic manipulator, the material application head and the radiation beam generator. The application head includes a material supply system for supplying the UHMW polymer material, a material cutting mechanism for cutting lengths of the UHMW polymer material supplied by the material supply system, and a compaction roller for compacting the lengths of UHMW polymer material against a substrate. The radiation beam generator may be one of an electron beam generator, and a gamma-ray beam generator. The end effector includes a mounting plate, and the material application head and the radiation beam generator are mounted on the mounting plate.

### BRIEF DESCRIPTION OF THE DRAWINGS

The novel features believed characteristic of the illustrative embodiments are set forth in the appended claims. The illustrative embodiments, however, as well a preferred mode of use, further objectives and advantages thereof, will best be understood by reference to the following detailed description of an illustrative embodiment of the present disclosure when read in conjunction with the accompanying drawings, wherein:

FIG. 1 is an illustration of a flow diagram of a method of fabricating UHMW polymer laminates.

FIG. 2 is an illustration of a cross-sectional view of a portion of a laminate being laid up and irradiated by an electron beam.

FIG. 3 is an illustration of a diagrammatic, side view of one form of an apparatus for fabricating a UHMW polymer laminate structure.

FIG. 4 is an illustration of a perspective view of a UHMW polymer laminate being irradiated with an electron beam.

FIG. 5 is an illustration similar to FIG. 4, but showing irradiation with gamma-rays.

FIG. 6 is an illustration of the functional block diagram of apparatus for laying up and irradiating a UHMW polymer laminate.

FIG. 7 is an illustration of a perspective view of one form of the apparatus shown in FIG. 6.

FIG. 8 is an illustration of a diagrammatic end view of an enclosed UHMW polymer laminate being irradiated from within its interior.

FIG. 9 is an illustration of a flow diagram of aircraft production and service methodology.

FIG. 10 is illustration of a block diagram of an aircraft.

### DETAILED DESCRIPTION

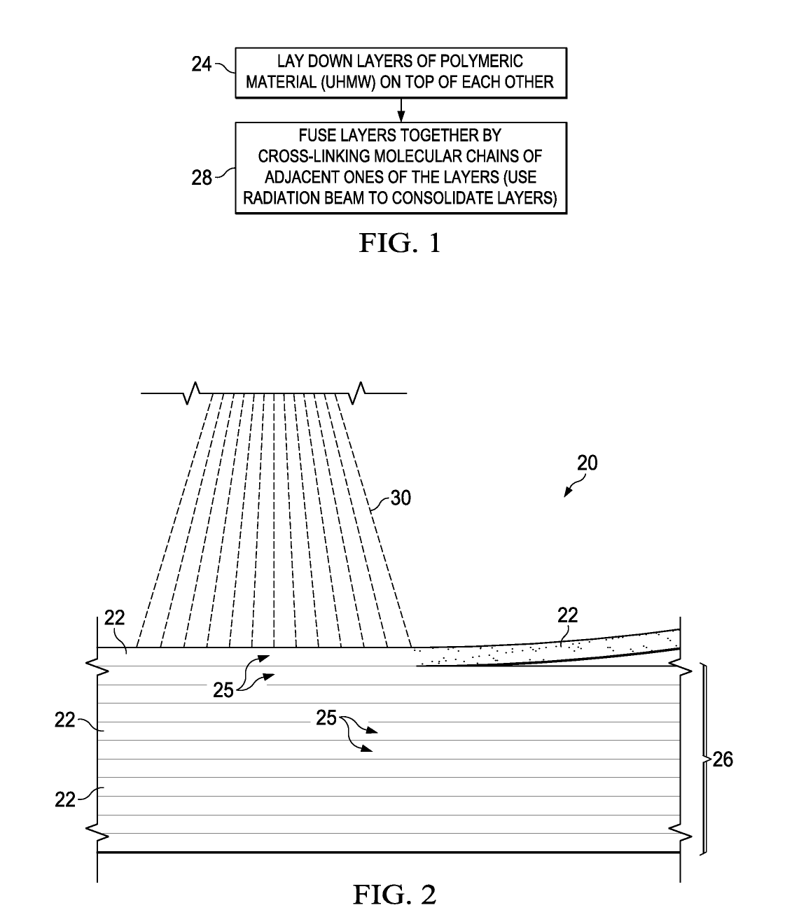

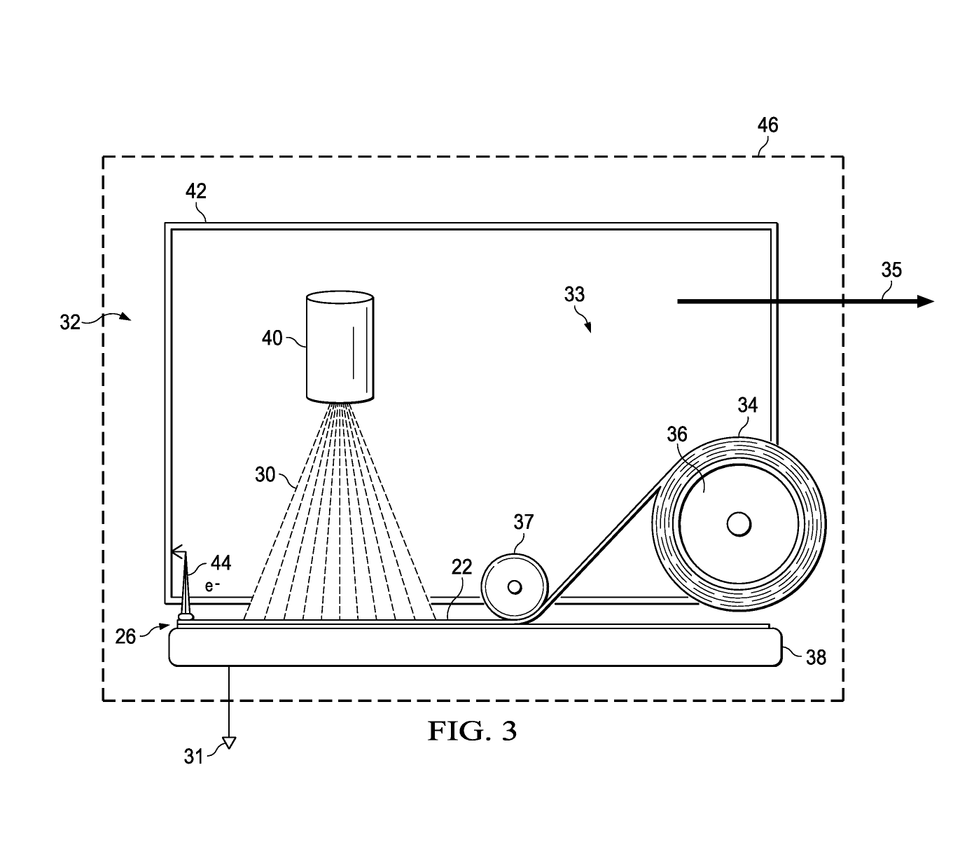

Referring first to FIGS. 1 and 2, the disclosed embodiments relate to a method of fabricating a polymer laminate structure 20, using a simple, two-step process broadly shown in FIG. 1. At step 24, layers 22 of a single or multiple branch UHMW polymer such as, without limitation, UHMWPE, are laid down on top of each other to form a laminate stack 26. Layers 22, which are placed on top of and are in face-to-face contact with an underlying layer 22, will be sometimes hereinafter referred to as “adjoining layers” 22. At step 28, the layers 22 are fused together by cross-linking 25 molecular chains (not shown) in the adjoining layers 22, thereby integrating the laminate stack 26 into a consolidated structure 20. This cross-linking 25 of the molecular chains of adjoining layers 22 is achieved using a beam 30 (see FIG. 3) of radiation. The radiation causes the molecular chains to break and then reform, permitting the desired cross-linking of the molecular chains of the adjoining layers 22.

The radiation beam 30 may comprise, for example and without limitation, an electron beam or a gamma-ray beam. The strength (energy level) of the radiation beam 30 that is required to effect molecular chain breakage, re-forming and cross-linking 25 will depend upon the application, including the particular UHMW polymer material used, as well as the thickness and number of the layers 22. The disclosed method may be used to fabricate light weight, high strength polymer laminate structures that may not contain reinforcements, such as for example and without limitation fuselage segments, stringers, and beams used in the aerospace industry, to name only a few.

Radiation induced chain breakage and reforming of the molecular chains of the UHMW polymer, and the resulting cross-linking 25 of the laminate layers 22 may improve the strength, thermal characteristics, impact resistance, abrasion resistance and electrical resistance properties of the laminate structure 20, while maintaining other desired material properties. The radiation interacts with matter by transferring energy to the electrons orbiting the atomic nuclei of the target materials. Thus, by using radiation, it is possible to synthesize, modify, cross-link and/or degrade polymers. During irradiation, chain scissoring occurs simultaneously and competitively with the cross-linking, with the end result being determined by the ratio of the yields of the two reactions. The ratio of cross-linking to scissioning depends on several factors including the total irradiation dose, dose rate, the presence of oxygen, stabilizers and a radical scavengers, as well as steric hindrances derived from structural or crystalline forces. Where the layers 22 are irradiated with an electron beam 30, highly accelerated electrons produce direct ionization of the molecules of the polymer, whereas when the layers 22 are irradiated with a gamma-ray beam 30, the high frequency electromagnetic radiation results in indirect ionization of the molecules. Other suitable forms of radiation may be employed to cause the cross-linking and scissioning of the of the UHMW polymer molecules.

In one embodiment, each of the layers 22 is subjected to the radiation beam 30 as it is being laid down on top of another layer 22. However, depending upon the strength (energy level) of the radiation beam 30, the thickness of the layers 22 and the rate at which radiation beam is moved across the stack 26, it may be possible to cross-link 25 the molecular chains of more than two of the layers 22 simultaneously. Thus, for example, it may be possible to lay down a group of two or more layers 22 after which the group of layers 22 is subjected to the radiation beam 30 in order to cross-link the molecular chains of the adjoining layers 22. By successively fusing the adjoining layers 22 by this molecular cross-lining process, the layers 22 in the stack 26 are integrated with each other and become consolidated into a single polymer structure 20.

As will be discussed below in more detail, any of various techniques may be employed to lay down the individual layers 22 of the stack 26, including but not limited to the use of well-known automated material placement equipment (not shown). The fusing of the layers 22 caused by the irradiation described above results in a laminated structure 20 in which the layers 22 are no longer distinct and separate from each other, but rather are integrated to form a substantially continuous, generally uniform unitary structure. It should be noted here that while the disclosed method permits fabrication of UHMW polymer laminates that are unreinforced, the method may also be employed to fabricate UHMW polymer laminates that have reinforcements which may be either continuous or discontinuous. In those laminate applications employing reinforcements, such as fiber reinforcements, the presence of the reinforcements, including the orientation of the unidirectional reinforcements, will generally not have any substantially effect on ability of the polymer layers 22 to cross-link and fuse together.

In some embodiments of the method, it may be desirable to heat the layers 22 either before, during or after they are irradiated. For example, in some applications, the UHMW polymer materials from which the layers 22 are formed may be a hybrid material that includes both thermoplastic and thermosetting material components. In this case, it may be necessary to maintain the raw hybrid polymer material in a cold state to prevent its degradation, but prior use, it may be necessary to heat the raw material to bring it up to at least room temperature before it is laid down on a substrate and irradiated. It may also be desirable to heat the laminate structure 20 following irradiation in order to eliminate undesirable free radicals that may be caused by the radiation.

Attention is now directed to FIG. 3, which illustrates one embodiment of apparatus 32 for carrying out the method shown in FIG. 1. The apparatus 32 broadly comprises a material supply system 33 and a radiation beam generator 40 mounted on a frame 42 that is movable in a desired direction 35 over a substrate such as a tool 38. The material supply system 33 may include a reel 36 of raw UHMW polymer material 34 which is dispensed as the apparatus 32 moves over the tool 38. The raw UHMW polymer material 34 is fed to a compaction roller 37 which guides and compacts layers 22 of the material 34 either onto the tool 38 or onto an underlying layer 22. The radiation beam generator 40 is positioned on the frame 42 such that a radiation beam 30 is directed onto layers 22 immediately after they are laid down on top of another layer 22. As previously mentioned, radiation beam generator 40 may comprise an electron beam generator 40, or a source of gamma-rays that is directed as a beam 30 onto the surface of the layers 22. Other types of radiation sources may be employed, depending upon the particular type of UHMW polymer material that is used, providing that the radiation beam generator is capable of effecting scissioning and cross-linking 25 of the molecular chains of adjoining ones of the layers 22.

In those versions of the apparatus 32 employing an electron beam generator 40 which bombards the laminate with electrons, an electrostatic charge e⁻ may accumulate on the apparatus 32. This electrostatic charge e⁻ may create an electrical potential difference that results in an undesirable electrical discharge between the apparatus 32 and the laminate structure 20 which may adversely affect the laminate structure 20. This accumulated electrostatic charge e⁻ may be drained away by a set of brush contacts 44 which are mounted on the frame 42 and contact the top layer 22 as the apparatus 32 moves over the tool 38. The charge e⁻ is discharged to a ground 31 coupled with the tool 38.

In order to prevent oxidation of the molecules of the UHMW polymer, irradiation of the layers 22 by the radiation beam generator 40 and the resultant fusion of the layers 22, may be carried out in an environment 46 that is free or nearly completely free of oxygen. This may be accomplished by performing the radiation treatment in a vacuum, or within an environment 46 in which air has been completely or nearly completely replaced by an inert gas such as, without limitation, nitrogen, such that the UHMW polymer is substantially non-reactive with any gases that may be present in the environment 46. Although not shown in the Figures, the apparatus 32 may include a suitable form of heater to heat the material 34 before the layers 22 are placed, or as the layers 22 are being placed. Also, the laminate structure 20 may be heated, as by placing it in an oven (not shown), after it has been laid up and fused, either for the purpose of re-softening it so that it can be formed to a desired shape, or in order to affix it to another structure.

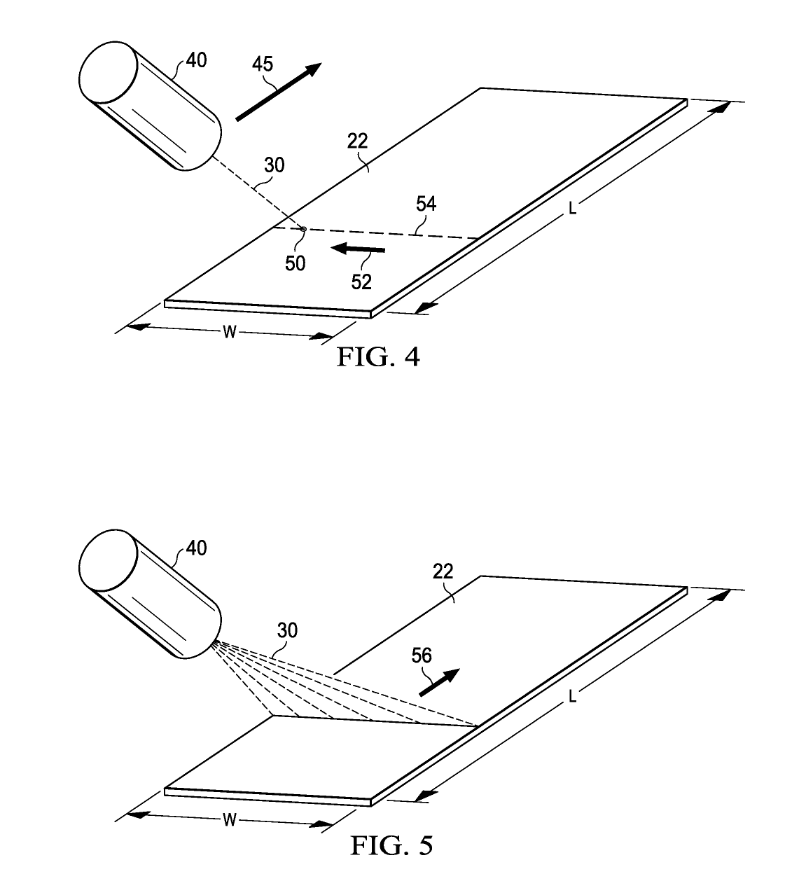

Irradiation of the layers 22 may be carried out using any of several techniques. For example, referring to FIG. 4, an electron beam 30 is directed onto a layer 22 as a spot 50. The beam 30 may be scanned 52 across the width “W” of the layer 22 in a raster-like manner, as a radiation beam generator 40 is moved 45 along the length “L” of the layer 22. In other embodiments, rather than moving the radiation beam generator 40 along the length “L” of the layer 22, the radiation beam generator 40 may include a scanner (nor shown) which displaces the radiation beam 30 along the length “L” as raster scanning across the width “W” is performed. FIG. 5 illustrates another technique for irradiating the layers 22. In this embodiment, a fan-like beam 30 of gamma-rays impinges the layer 22 as a line which is then moved in either an incremental or continuous manner 56 along the length “L” of the layer 22. A variety of other techniques for irradiating the layers 22 may be possible.

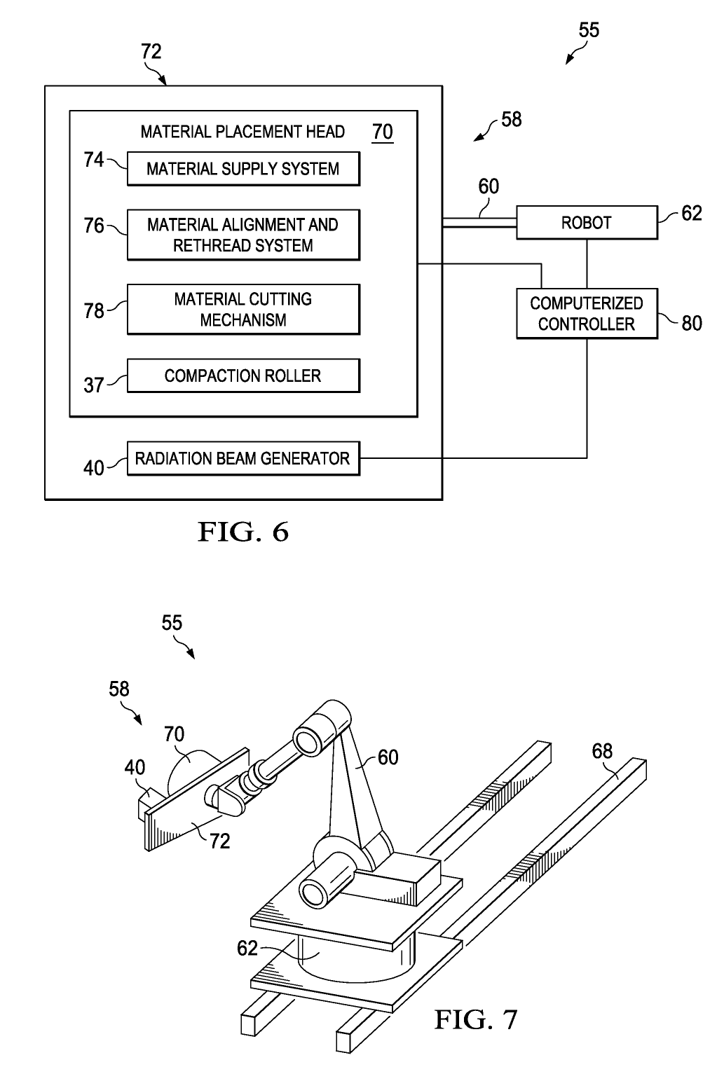

FIGS. 6 and 7 illustrate another embodiment of an apparatus 55 for fabricating a UHMW polymer laminate in which the laminate layers 22 are fused together and strengthened by the layer-by-layer irradiation method previously described. The apparatus 55 broadly comprises an end effector 58 that includes a material placement head 70 and a radiation beam generator 40. The end effector 58 is manipulated by a robot 62. The robot 62 is mounted for linear movement along rails 68 and includes an articulated arm 60 having a tool mounting plate 72 on which the end effector 58 is mounted.

The material placement head 70 may include a material supply system 74, a material alignment and a re-thread system 76, a material cutting mechanism 78, and a compaction roller 37. The material placement head 70 may be similar to those described in U.S. Pat. No. 7,213,629, U.S. patent application Ser. No. 12/038,155 filed Feb. 27, 2008 and US Patent Publication No. 20070029030 published Feb. 8, 2007, the entire contents of which are incorporated by reference herein. The material placement head 70 simultaneously lays down substantially parallel strips (not shown) of the UHMW polymer material forming conformal bands that are irradiated as they are laid down on a substrate such as a mandrel or other tool (not shown). The radiation beam generator 40 is mounted and positioned on the tool mounting plate 72 such that it directs a radiation beam (FIGS. 4 and 5) onto the surface of layers 22 of material that are placed by the material placement head 70, as the robot 62 moves the end effector 58 over the substrate. The robot 62, as well as the functions of the material placement head 70 and the radiation beam generator 40, are controlled by a computerized controller 80.

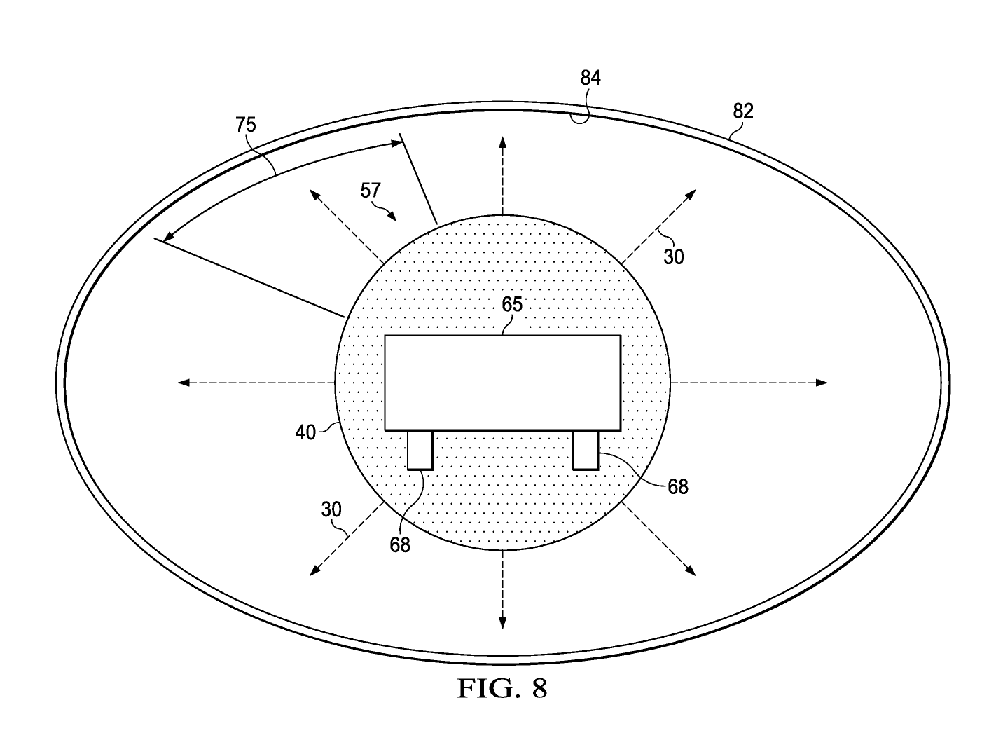

The method of fabricating UHMW polymer laminates previously described may be employed to produce partially or fully enclosed structures that have generally open interiors. For example, referring to FIG. 8, the disclosed method may be used to fabricate a UHMW polymer laminate aircraft fuselage 82, which in the illustrated example, has a cross-sectional shape that is generally oval, and an open interior 57. The UHMW polymer laminate aircraft fuselage 82 may have any of a variety of other cross sectional shapes, however. Layers 22 of the laminate fuselage 82 may be laid up on an OML (outer mold line) tool (not shown) using an automated material placement machine similar to that previously described in connection with FIGS. 6 and 7. As the layers 22 of the laminate fuselage 82 are laid up, they are fused together with one or more underlying layers 22 using a radiation beam generator 40 that directs radiation beams 30 onto the layers 22.

The radiation beam generator 40 is mounted on a carriage 65, and the carriage 65 is mounted on a set of rails 68 which pass longitudinally through the open interior 57 of the fuselage 82. Alternatively, the radiation beam generator 40 may be moved through the open interior 57 of the fuselage 82 by a robotic device (not shown). The radiation beam generator 40 may include a scanning mechanism which rotates the radiation beam 30 circumferentially as the radiation beam generator 40 is moved through the open interior 57. Alternatively, multiple radiation beam generators 40 may be mounted on the carriage 65 and oriented in different radial directions so as to simultaneously irradiate adjacent circumferential sections 75 of the layers 22 as the carriage 65 moves through the open interior 57 the fuselage 82.

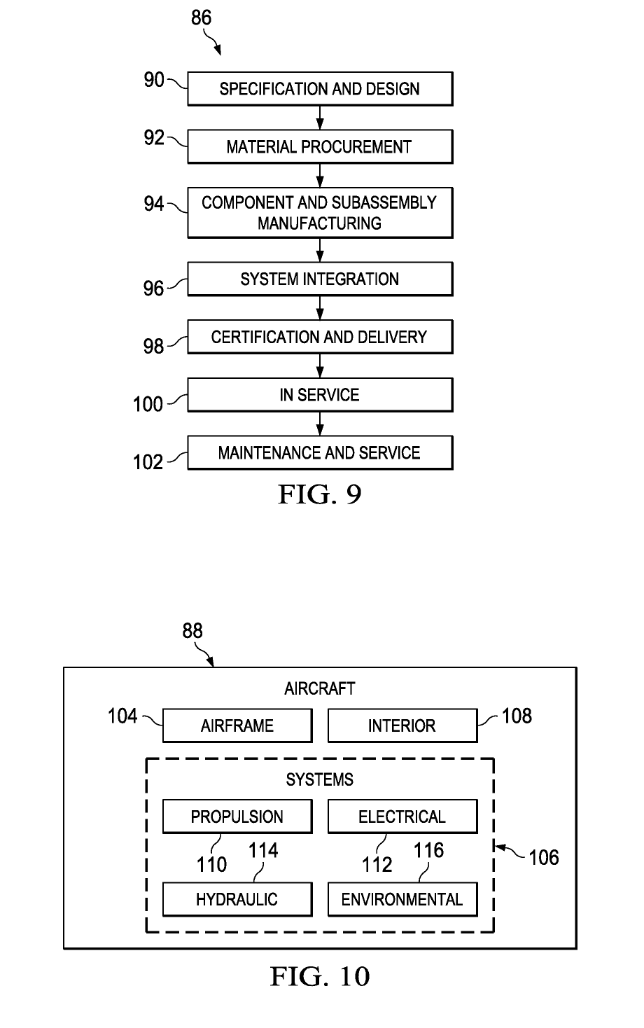

Embodiments of the disclosure may find use in a variety of potential applications, particularly in the transportation industry, including for example, aerospace, marine, automotive applications and other applications requiring rapid and efficient fabrication of light-weight, high strength polymer laminate parts. Referring now to FIGS. 9 and 10, embodiments of the disclosure may be used in the context of an aircraft manufacturing and service method 86 as shown in FIG. 9, and an aircraft 88 as shown in FIG. 10. Aircraft applications of the disclosed embodiments may include, for example, without limitation, fuselage sections, beams and stringers, to name only a few parts. During pre-production, exemplary method 86 may include specification and design 90 of the aircraft 88 and material procurement 92. During production, component and subassembly manufacturing 94 and system integration 96 of the aircraft 88 takes place. Thereafter, the aircraft 88 may go through certification and delivery 98 in order to be placed in service 100. While in service by a customer, the aircraft 88 is scheduled for routine maintenance and service 102, which may also include modification, reconfiguration, refurbishment, and so on.

Each of the processes of method 86 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 10, the aircraft 88 produced by exemplary method 86 may include an airframe 104 with a plurality of systems 106 and an interior 108. Examples of high-level systems 106 include one or more of a propulsion system 110, an electrical system 112, a hydraulic system 114, and an environmental system 116. Any number of other systems may be included. Although an aerospace example is shown, the principles of the disclosure may be applied to other industries, such as the marine and automotive industries.

Systems and methods embodied herein may be employed during any one or more of the stages of the production and service method 86. For example, components or subassemblies corresponding to production process 94 may be fabricated or manufactured in a manner similar to components or subassemblies produced while the aircraft 88 is in service. Also, one or more apparatus embodiments, method embodiments, or a combination thereof may be utilized during the production stages 94 and 96, for example, by substantially expediting assembly of or reducing the cost of an aircraft 88. Similarly, one or more of apparatus embodiments, method embodiments, or a combination thereof may be utilized while the aircraft 96 is in service, for example and without limitation, to maintenance and service 102.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method fabricating a polymer structure, comprising:
laying down layers of an ultra-high molecular weight (UHMW) polymer material on top of each other; and
fusing the layers into a consolidated laminate by cross-linking molecular chains of adjoining ones of the layers.

2. The method of claim 1, wherein cross-linking the molecular chains is performed by subjecting each of the layers to a beam of radiation.

3. The method of claim 2, wherein subjecting each of the layers to a beam of radiation is performed in an environment that is nearly completely free of oxygen.

4. The method of claim 2, further comprising heating the layers of UHMW polymer material.

5. The method of claim 2, wherein subjecting each of the layers of UHMW polymer material to a beam of radiation includes scanning an electron beam over the layer.

6. The method of claim 5, wherein scanning an electron beam over the layers of UHMW polymer material results in an accumulation of an electrostatic charge on the layers, and the method further comprises draining the electrostatic charge from the layers of UHMW polymer material.

7. The method of claim 2, wherein subjecting each of the layers to a beam of radiation includes scanning a beam of gamma-rays over the layer.

8. The method of claim 2, wherein the UHMW polymer material is a UHMW polyethylene.

9. The method of claim 2, wherein:
laying down a plurality of layers of a polymer material is performed using a computer controlled automatic material placement head to place strips of the polymer material in side-by-side relationship on a substrate, and
subjecting each of the layers of the polymer material to a beam of radiation is performed by scanning a beam of radiation across the strips as the strips are being placed on the substrate.

10. The method of claim 1, wherein:
laying down a plurality of layers of a polymer material on top of each other includes placing strips of the polymer material on a substrate and compacting the strips as they are being placed on the substrate, and
cross-linking the molecular chains of adjoining ones of the layers includes subjecting each of the strips to a beam of radiation after the strip has been compacted.

11. A method of fabricating an ultra-high molecular weight (UHMW) polymer structure, comprising:
placing layers of a UHMW polymer material on top of each other; and
consolidating the layers, including cross-linking molecular chains of the layers by subjecting the layers to radiation sufficient in dosage to cross-link the molecular chains in adjoining ones of the layers.

12. The method of claim 11, wherein the UHMW polymer material includes UHMW polyethylene.

13. The method of claim 11, wherein subjecting the layers to radiation includes scanning the layers with one of:
an electron beam, and
a gamma-ray beam.

14. The method of claim 11, further comprising:
preventing oxidation of the molecular chains by removing oxygen from an environment surrounding the layers before the layers are subjected to the radiation.

15. A method of increasing the structural integrity of an ultra-high molecular weight (UHMW) polymer laminate, comprising:
breaking polymer bonding chains of layers of the laminate and cross-linking molecular chains of the layers by subjecting the layers with a beam of radiation.

16. The method of claim 15, wherein subjecting the layers with a beam of radiation is performed by passing one of an electron beam and a gamma-ray beam over the layers.

17. The method of claim 15, wherein the UHMW polymer laminate is a UHMW polyethylene laminate.

18. The method of claim 15, further comprising removing oxygen from a volume surrounding the laminate while the layers are being subjected to the beam of radiation.

19. The method of claim 13, further comprising heating the laminate.

20. A method of fabricating a generally enclosed polymer structure having an open interior, comprising:
forming a generally enclosed multi-layer laminate having an open interior, including placing layers of an ultra-high molecular weight (UHMW) polymer material on top of each other layer-by-layer; and
fusing the layers to each other by irradiating the layers with radiation from within the open interior of the laminate.

21. The method of claim 20, wherein irradiating the layers includes moving a radiation beam generator through the open interior of the laminate and directing a radiation beam radially outwardly as the layers are being placed.

22. Apparatus for fabricating a UHMW polymer structure, comprising:
an end effector, including an UHMW polymer material placement head adapted to place layers of the UHMW polymer material on a substrate, and a radiation beam generator for fusing layers applied by the placement head;
a robot for manipulating the end effector; and
a computerized controller for automatically controlling operation of the robot, the material placement head and the radiation beam generator.

23. The apparatus of claim 22, wherein:
the placement head includes a material supply system for supplying the UHMW polymer material,
a material cutting mechanism for cutting lengths of the UHMW polymer material supplied by the material supply system,
a compaction roller for compacting the lengths of UHMW polymer material against a substrate.

24. The apparatus of claim 22, wherein the radiation beam generator is one of:
an electron beam generator, and
a gamma-ray beam generator.

25. The apparatus of claim 22, wherein:
the end effector includes a mounting plate, and
the material placement head and the radiation beam generator are mounted on the mounting plate.
